(19) United States
(12) Patent Application Publication
(10) Pub. No.: US 2016/0362056 A1
(43) Pub. Date: Dec. 15, 2016

(54) ROOF RACK CROSSBAR ASSEMBLY

(71) Applicant: Cequent Performance Products Inc., Plymouth, MI (US)

(72) Inventors: Brian Ward, Swartz Creek, MI (US); David Lester Pinkston, Novi, MI (US)

(21) Appl. No.: 15/180,833

(22) Filed: Jun. 13, 2016

Related U.S. Application Data
(60) Provisional application No. 62/174,018, filed on Jun. 11, 2015.

(51) Int. Cl. B60R 9/05

(52) U.S. Cl. CPC B60R 9/05

(57) ABSTRACT

A crossbar assembly for a roof rack configured to be selectively attached to a vehicle, the crossbar assembly is shown and described. The crossbar includes a body having a length and cross-sectional profile with a generally aerofoil shape. The cross-sectional profile may include a base portion attached to a nose portion. The nose portion may include a leading edge having a rounded profile. A first plane surface may extend rearwardly from the leading edge at an upward angle and terminate at a first shoulder. A second plane surface may extend rearwardly from the leading edge at a downward angle and terminate at a second shoulder. The crossbar may be configured to be mounted to an associated vehicle and reduce wind noise across the nose portion and base portion of the body.

### CROSS-REFERENCE TO RELATED APPLICATIONS

This application claims the benefit of U.S. Patent Application No. 62/174,018, filed Jun. 11, 2015 and entitled “Roof Rack Crossbar Assembly,” which is hereby incorporated by reference.

### FIELD OF INVENTION

The present invention is generally related to roof rack for stowing various items on top of a vehicle; and more particularly to a roof rack configured to reduce operating noise.

### BACKGROUND

Roof rack assemblies are a common way luggage is stowed on a vehicle during travel. It has become commonplace to use the roof of a vehicle to stow items which do not fit inside the vehicle. There are many different types of roof racks available that are used on many different types of vehicles, such as mini-vans, sport utility vehicle, cars, and the like. However, since these roof racks typically extend across the roof of the vehicle in a manner perpendicular to the direction of vehicle travel, there is often a substantial amount of wind noise produced by the vehicle while driving down the road. This wind noise is considered undesirable, and several roof rack designs have been made to attempt reduce or eliminate wind noise with poor results.

Wind noise reduction techniques include providing movable crossbars that may be placed in a use position for stowing luggage and a stowed position when not in use. Further, adding ribs, beads or protrusions have been added about the surface of the crossbeam. However, these features add complexity and additional moving parts that may increase cost and maintenance requirements. Further, these features may not sufficiently address high-pitched noises that may be caused by existing embodiments. The protrusions may also cause assembly interferences with various mating components.

Accordingly, the disclosed roof rack assembly may solve the problems that exist in the prior art and may be utilized for stowing luggage during travel, while at the same time providing a reduction in wind noise.

### SUMMARY

A crossbar assembly for a roof rack configured to be selectively attached to a vehicle; the crossbar assembly is shown and described. The crossbar includes a body having a length and cross-sectional profile with a generally aerofoil shape. The cross-sectional profile may include a base portion extending the length of the body and a nose portion attached to the body portion. The nose portion comprising a leading edge having a generally rounded profile, a first plane extending rearwardly from the leading edge at an upward angle that terminates at a first shoulder, and a second plane extending rearwardly from the leading edge at a downward angle that terminates at a second shoulder. The crossbar may be configured to be mounted to a vehicle and reduce wind noise across the nose portion and base portion of the body. The base portion may be attached to the nose portion along the first shoulder and second shoulder. The base portion and nose portion have a continuous unitary construction. The base portion may further comprise a top surface, bottom surface, and rear surface. The top surface may extend from the first shoulder to the rear surface. The bottom surface of the base portion may extend from the second shoulder to the rear surface. The rear surface may have a generally rounded profile. The bottom surface may be thicker than the top surface. The nose portion may extend the length of the body. The base member may include a first structural member and a second structural member, whereby the first structural member is attached to the bottom surface and the top surface and the second structural member is attached to the bottom surface and the top surface. The first and second structural members may extend the length of the body. The body may have a curvilinear orientation along the length of the crossbar. The base portion may include a base width from the top surface to the bottom surface, the nose portion may include a nose width from the first shoulder to the second shoulder along a common axis wherein the base width is greater than the nose width.

In another embodiment, provided is a crossbar assembly that comprises a body having a length and cross-sectional profile with a generally aerofoil shape. The cross-sectional profile comprises a base portion that may extend the length of the body and a nose portion attached to the body portion. The nose portion comprises a first recessed ledge having a surface defined by a first angle and a second recessed ledge having a surface defined by a second angle. The first and second recessed ledges may extend along the length of the body. The crossbar may be configured to be mounted to a vehicle and reduce wind noise across the nose portion and base portion of the body. The first recessed ledge and the second recessed ledge may be aligned along a common axis. The common axis may extend generally perpendicular relative to the length of the body. The first angle may be greater than the second angle along the common axis. The first angle may be between 10 degrees and 25 degrees and more particularly, about 15 degrees to 20 degrees or about 17 degrees. The second angle may be between 5 degrees and 25 degrees and more particularly, about 10 degrees to 20 degrees or about 13 degrees. The first and second recessed ledges may include a profile shape of at least one of round, oval, square or rectangular recessed grooves within the surface of the crossbar. The first and second recessed ledges may be formed into the crossbar assembly by removing material therefrom to form a profile shape. The first and second recessed ledges may be monolithically formed with the crossbar assembly. The nose portion may include surfaces that are generally smooth without sharp edges to assist with reducing wind noise. The crossbar assembly may include apertures aligned with a first cavity of the base portion for selective attachment to a roof of a vehicle.

### DESCRIPTION OF THE DRAWINGS

Operation of the invention may be better understood by reference to the following detailed description taken in connection with the following illustrations, wherein:

FIG. 1A is a top view of embodiments of a crossbar assembly in accordance with the disclosure;

FIG. 1B is a side view of embodiments of a crossbar assembly in accordance with the disclosure;

FIG. 1C is a bottom view of embodiments of a crossbar assembly in accordance with the disclosure;

FIG. 2 is a cross sectional view of the crossbar assembly along line 2-2 of FIG. 1B;

FIG. 3 is a partial cross-sectional view of a nose portion of the crossbar assembly;

FIG. 4 is a partial cross sectional view of the crossbar assembly;

FIG. 5 is a perspective cut-out view of the crossbar assembly;

FIG. 6 is an exploded bottom view of the crossbar assembly; and

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

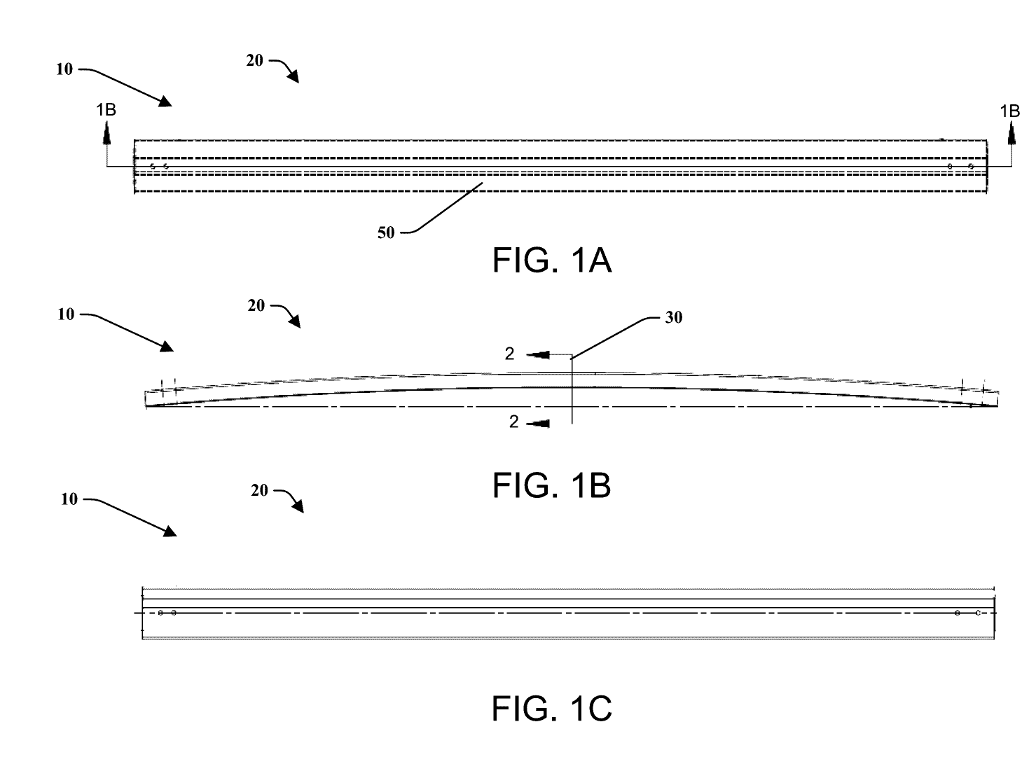

As illustrated by FIGS. 1-6, provided is a crossbar assembly 10 for a roof rack configured to be selectively attached to a vehicle. Vehicle crossbars may produce wind noise while traveling at various speeds, especially when traveling at high rates of speed. FIGS. 1A, 1B, and 1C illustrate an embodiment of the crossbar assembly 10. The crossbar assembly may include a body 20 having a length wherein the body 20 of the crossbar assembly may be designed to be positioned on a vehicle and support a load thereon. The length of the body 20 may have a generally straight configuration as illustrated by FIGS. 1A and 1C or the length of the body 20 may have a concaved configuration as illustrated by FIG. 1B.

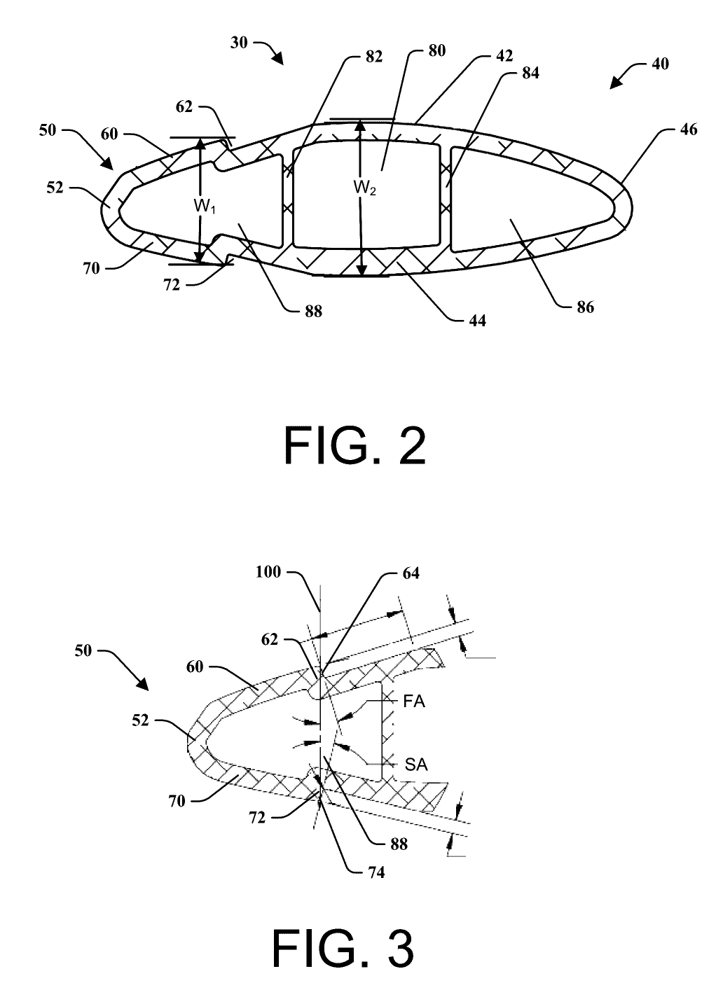

The crossbar assembly 10 may include cross-sectional profile 30 with a generally aerofoil shape. The aerofoil shape of the crossbar assembly 10 may include a recessed design that may allow for clearances for mating components and accessories. The recessed design may provide a noticeable noise reduction when attached to a vehicle. As illustrated by FIG. 2, the cross-sectional profile 30 may include a base portion 40 attached to a nose portion 50. The nose portion 50 may include a leading edge 52 having a generally rounded profile. A first plane surface 60 may extend rearwardly from the leading edge 52 at a generally upward angle and terminate at a first shoulder 62. A second plane surface 70 may extend rearwardly from the leading edge 52 at a generally downward angle and terminate at a second shoulder 72. The crossbar 10 may be configured to be mounted to an associated vehicle and reduce wind noise across the nose portion 50 and base portion 40 of the body 20. The crossbar 10 may be selectively or permanently attached with a roof assembly of any appropriate configuration in any appropriate manner. The present teachings are not limited to a specific configuration of roof bar and/or attachments thereto.

As illustrated by FIG. 2, the base portion 40 may be attached to the nose portion 50 along the first shoulder 62 and second shoulder 72. The base portion 40 and nose portion 50 may have a generally continuous unitary construction, i.e., it may be monolithically formed. The base portion 40 may further include a top surface 42, bottom surface 44, and rear surface 46 where the bottom surface 44 may be generally thicker than the top surface 42. The top surface 42 of the base portion 40 may extend from the first shoulder 62 to the rear surface 46. The bottom surface 44 of the base portion 40 may extend from the second shoulder 72 to the rear surface 46. The rear surface 46 may have a generally rounded profile. The nose portion 50 may extend the length of the body. The rear surface 46 may extend the length of the body 20.

The base portion 40 may define a first cavity 80 having a first structural member 82 attached to the bottom surface 44 and the top surface 42 and a second structural member 84 attached to the bottom surface 44 and the top surface 42. The first cavity 80 may extend the length of the body 20. The first structural member 82 may be generally parallel to the second structural member 84. A second cavity 86 may be defined within the second structural member 84 and the top surface 42, bottom surface 44, and rear surface 46. Additionally, a third cavity 88 may be defined by the first structural member 82, the top surface 42, the bottom surface 44, and the nose portion 50.

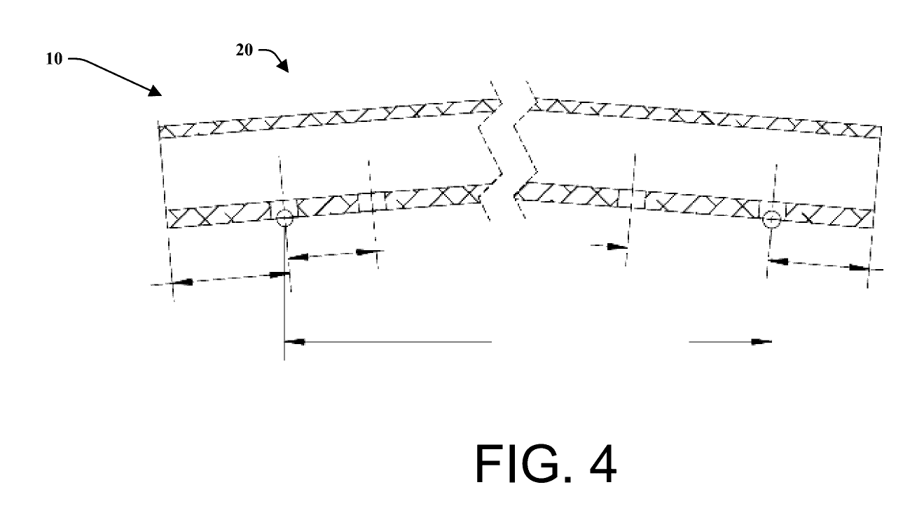

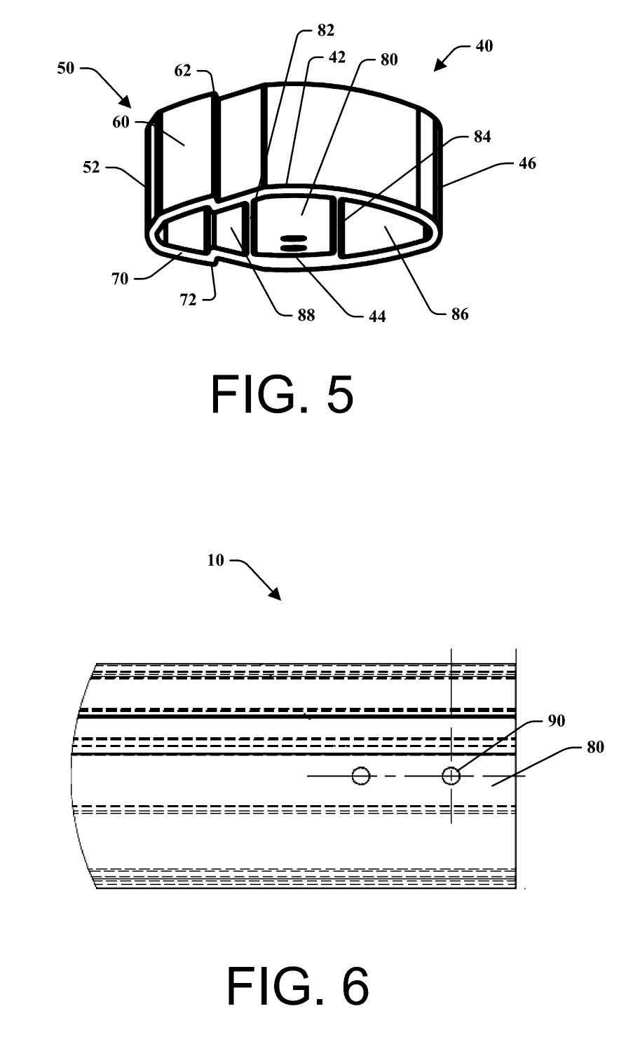

As illustrated by FIGS. 1B and 4, the body may have a generally curvilinear orientation along the length of the crossbar assembly 10. FIGS. 3 and 5 illustrate the geometric profile of the nose portion 50 in cross section and as the geometric profile extends along the length of the crossbar assembly 10. The first shoulder 62 may form a first recessed ledge 64 having a surface that is defined by a first angle FA. The second shoulder 72 may form a second recessed ledge 74 having a surface that is defined by a second angle SA. The first and second angles may be referenced from a common axis 100 whereas the first angle FA may be greater than the second angle SA. In particular, the first angle FA may be between 10 degrees and 25 degrees and more particularly, about 15 degrees to 20 degrees or about 17 degrees. The second angle SA may be between 5 degrees and 25 degrees and more particularly, about 10 degrees to 20 degrees or about 13 degrees. The ledges 64, 74 may include various configurations as they may be round, oval, square or rectangular recessed grooves within the surface of the crossbar. The ledges 64, 74 may be formed into the crossbar assembly 10 such as through removing material therefrom to form the ledges 64, 74. In addition or alternatively, the ledges 64, 74 may be monolithically formed with the crossbar assembly 10 when formed. The present teachings are not limited to the method of forming the ledges 64, 74. Any appropriate method of forming the ledges 64, 74 may be utilized.

In one embodiment, the length of the body 20 of the crossbar assembly 10 may be about 958 mm. A width of the body 20 of the crossbar may be about 60 mm. A height of the body 20 of the crossbar may be about 17.3 mm.

The position of the first shoulder 62 and the second shoulder 72 may be along the common axis 100. Further, the base portion 40 of the crossbar assembly 10 may have a width dimension W₂ from the top surface 42 and the bottom surface 44 along the first cavity 82 that is greater than a width dimension W₁ from the first shoulder 62 and the second shoulder 72 along the common axis 100. This may assist to reduce wind noise and allow proper clearances such as for assemblies—such as by way of a non-limiting example, cargo accessory assemblies—to be selectively attached to the crossbar 10 assembly.

The crossbar assembly 10 may change the airflow above and below it thereby reducing whistling or howling sounds. Further, additional recessed designs and or profiles could be applied to change, reduce, or eliminate objectionable wind noise that could be caused by the crossbars while driving. Specifically, the construction of the crossbar assembly 10 may allow wind to travel into the leading edge 52 of the nose portion 50. The wind will then move toward either or both of the first and second plane surfaces 60, 70. The wind will continue to travel back toward either or both of the shoulders 62, 72. The wind will then pass over the ledges 64, 74, which may reduce the wind noise passing over the crossbar assembly 10. Further still, surfaces of the nose portion 50 may be generally smooth and may not possess sharp edges, which may further assist with reducing wind noise.

The crossbar assembly 10 may be made from a structural material such as a metal, alloy, or polymer. In one embodiment, the crossbar assembly 10 is made of aluminum. Further, first plane surface 60 and second plane surface 70 may be generally free of heavy die lines and stickers. The crossbar assembly 10 may include apertures 90 for attachment to a roof rack of a vehicle. The apertures 90 may be aligned along the base portion 40 of the crossbar assembly 10 and may be particularly aligned with the first cavity 80 thereon.

Although the embodiments of the present invention have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

We claim:

1. A crossbar for a vehicle roof rack, the crossbar comprising:
a body having a length and cross-sectional profile with a generally aerofoil shape, the cross-sectional profile comprises:
a base portion extending the length of the body
a nose portion attached to the body portion, the nose portion comprising:
a leading edge having a generally rounded profile;
a first plane extending rearwardly from the leading edge at an upward angle and terminates at a first shoulder;
a second plane extending rearwardly from the leading edge at a downward angle and terminates at a second shoulder;
wherein the crossbar is configured to be mounted to a vehicle and reduce wind noise across the nose portion and base portion of the body.

2. The crossbar of claim 1, wherein the base portion is attached to the nose portion along the first shoulder and second shoulder.

3. The crossbar of claim 1, wherein the base portion and nose portion have a continuous unitary construction.

4. The crossbar of claim 1, wherein the base portion further comprises a top surface, bottom surface, and rear surface.

5. The crossbar of claim 4, wherein the top surface extends from the first shoulder to the rear surface, the bottom surface of the base portion extends from the second shoulder to the rear surface, the rear surface having a generally rounded profile.

6. The crossbar of claim 4, wherein the bottom surface is thicker than the top surface.

7. The crossbar of claim 1, wherein the nose portion extends the length of the body.

8. The crossbar of claim 1, wherein the base member includes a first structural member and a second structural member, whereby the first structural member is attached to the bottom surface and the top surface and the second structural member is attached to the bottom surface and the top surface, the first and second structural members extending the length of the body.

9. The crossbar of claim 1, wherein the body may have a curvilinear orientation along the length of the crossbar.

10. The crossbar of claim 1, wherein the base portion includes a base width from the top surface to the bottom surface, the nose portion includes a nose width from the first shoulder to the second shoulder along a common axis, wherein the base width is greater than the nose width.

11. A crossbar assembly comprising:
a body having a length and cross-sectional profile with a generally aerofoil shape, the cross-sectional profile comprises:
a base portion that extends the length of the body;
a nose portion attached to the body portion, the nose portion comprising:
a first recessed ledge having a surface defined by a first angle; and
a second recessed ledge having a surface defined by a second angle, wherein the first and second recessed ledges extend along the length of the body.
wherein the crossbar is configured to be mounted to a vehicle and reduce wind noise across the nose portion and base portion of the body.

12. The crossbar assembly of claim 11, wherein the first recessed ledge and the second recessed ledge are aligned along a common axis, the common axis extends generally perpendicular relative to the length of the body.

13. The crossbar assembly of claim 12, wherein the first angle is greater than the second angle along the common axis.

14. The crossbar assembly of claim 11, wherein the first angle is between 10 degrees and 25 degrees and more particularly, about 15 degrees to 20 degrees or about 17 degrees.

15. The crossbar assembly of claim 11, wherein the second angle is between 5 degrees and 25 degrees and more particularly, about 10 degrees to 20 degrees or about 13 degrees.

16. The crossbar assembly of claim 11, wherein the first and second recessed ledges includes a profile shape of at least one of round, oval, square or rectangular recessed grooves within the surface of the crossbar.

17. The crossbar assembly of claim 11, wherein the first and second recessed ledges are formed into the crossbar assembly by removing material therefrom to form a profile shape.

18. The crossbar assembly of claim 11, wherein the first and second recessed ledges are monolithically formed with the crossbar assembly.

19. The crossbar assembly of claim 11, wherein the nose portion includes surfaces that are generally smooth without sharp edges to assist with reducing wind noise.

20. The crossbar assembly of claim 11, wherein the crossbar assembly includes apertures aligned with a first cavity of the base portion for selective attachment to a roof of a vehicle.
